(19) United States
(12) Patent Application Publication
(10) Pub. No.: US 2019/0003616 A1
(43) Pub. Date: Jan. 3, 2019

(54) Magnetic Cable Hanger

(71) Applicant: Joseph K. Wargo, Spicewood, TX (US)

(72) Inventor: Joseph K. Wargo, Spicewood, TX (US)

(21) Appl. No.: 15/883,868

(22) Filed: Jan. 30, 2018

Related U.S. Application Data
(60) Provisional application No. 62/452,016, filed on Jan. 30, 2017.

(51) Int. Cl. F16L 3/12

(52) U.S. Cl. CPC F16L 3/1222; F16B 2/245

(57) ABSTRACT

In some embodiments, a device may include a magnet and a mounting base coupled to the magnet and including one or more clip openings. The device may further include one or more cable clips configured to secure at least one of a cable and a conduit. Further, each cable clip may be configured to couple to a corresponding clip opening of the mounting base.

The present application is a non-provisional of and claims priority to U.S. Provisional Patent Application No. 62/452,016 filed on Jan. 30, 2017 and entitled “Magnetic Cable Hanger”, which is incorporated herein by reference in its entirety.

### FIELD

The present disclosure is generally related to a magnetic cable hanger, and more particularly to a cable hanger including a structure configured to secure a cable or cable conduit to a metallic structure using a magnet.

### BACKGROUND

To facilitate radio frequency transmissions, radio frequency (RF) transceiver system including transceiver devices (such as dish antennae, cellular antennae, other receiver/transmitter devices, or any combination thereof) and associated electronic equipment and circuitry may be positioned at a selected height above the ground. In some examples, radio frequency towers (such as cellular towers) may be constructed to secure such RF transceivers. In some instances, the RF transceivers may be coupled to existing structures (such as water towers, building heating, ventilation and air conditioning systems, and the like).

### SUMMARY

In an embodiment, a device may include a magnet and a mounting base coupled to the magnet and including one or more clip openings. The device may further include one or more cable clips configured to secure at least one of a cable and a conduit. Further, each cable clip may be configured to couple to a corresponding clip opening of the mounting base.

In some embodiments, a device may include a mounting base including a magnet configured to couple to a support structure, and further including at least one clip opening. The device may further include at least one cable clip. Each cable clip may include a first portion and a connection portion. The first portion may be configured to secure at least one of a cable and a conduit. The connection portion may be configured to engage the at least one clip opening to couple the at least one clip to the mounting base.

In other embodiments, a device may include a magnet and a mounting base coupled to the magnet and including one or more clip openings. The device may further include one or more cable clips configured to secure at least one of a cable and a conduit. Each cable clip may be configured to couple to a selected one of the one or more clip openings of the mounting base.

In still other embodiments, a method can include magnetically coupling a mounting base to a structure. The mounting base can include a plurality of clip openings. The method may further include mechanically coupling an attachment feature of a cable clip at least one of the plurality of openings. The cable clip may include a first portion configured to secure at least one of a cable and a conduit to the structure.

### BRIEF DESCRIPTION OF THE DRAWINGS

FIG. 1 depicts a side view of a system including an antenna device mounted to a water tower and including cables extending from the antenna device to the ground and secured by a magnetic cable hanger, in accordance with certain embodiments of the present disclosure.

FIG. 2 depicts a side view of a magnetic cable hanger including a cable clip coupled to a mounting base, in accordance with certain embodiments of the present disclosure.

FIG. 3 depicts a side view of the magnetic cable hanger including a pair of cable clips coupled to the mounting base, in accordance with certain embodiments of the present disclosure.

FIG. 4 depicts a side view of a magnet cable hanger, in accordance with certain embodiments of the present disclosure.

FIG. 5 depicts a top perspective view of a magnet cable hanger, in accordance with certain embodiments of the present disclosure.

FIG. 6A depicts a top view of a sheet of material including cut outs and bend-lines for forming a cable clip, such as the cable clip of FIGS. 2-5, in accordance with certain embodiments of the present disclosure.

FIG. 6B depicts a top view of the sheet of material after bending to form the cable clip of FIGS. 2-5, in accordance with certain embodiments of the present disclosure.

FIG. 6C illustrates a bottom view of the cable clip of FIG. 6C, in accordance with certain embodiments of the present disclosure.

FIG. 7 depicts a flow diagram of a method of installing a magnetic cable hanger, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

In an example, cables may be used to electrically couple an antenna device mounted to a water tower to a power source or other devices on or near the ground. In certain instances, it may be desirable (or necessary based on governmental regulations, for example) to secure the cables. Embodiments of a magnetic cable hanger are described below that can include a mounting base configured to couple to a permanent magnet, such as a rare earth magnet. The permanent magnet may be used to secure the mounting base to a supporting structure, such as a surface of a water tower (in this particular example). Further, the magnetic cable hanger may include a cable clip including a configured to engage one or more cables (or cable conduits) and to secure them to the legs or support structure of the water tower.

In some embodiments, the cable hanger may include a mounting base portion that may include or be coupled to a magnet, which may be configured to couple the base portion to a support structure. The support structure may be formed from any material that attracts magnets, such as metal that contains iron, cobalt, nickel, or any combination thereof. The cable hanger may further include a clip portion configured to engage one or more cables or a cable conduit and to releasably attach to the mounting base portion to secure the cables or cable conduit to the support structure.

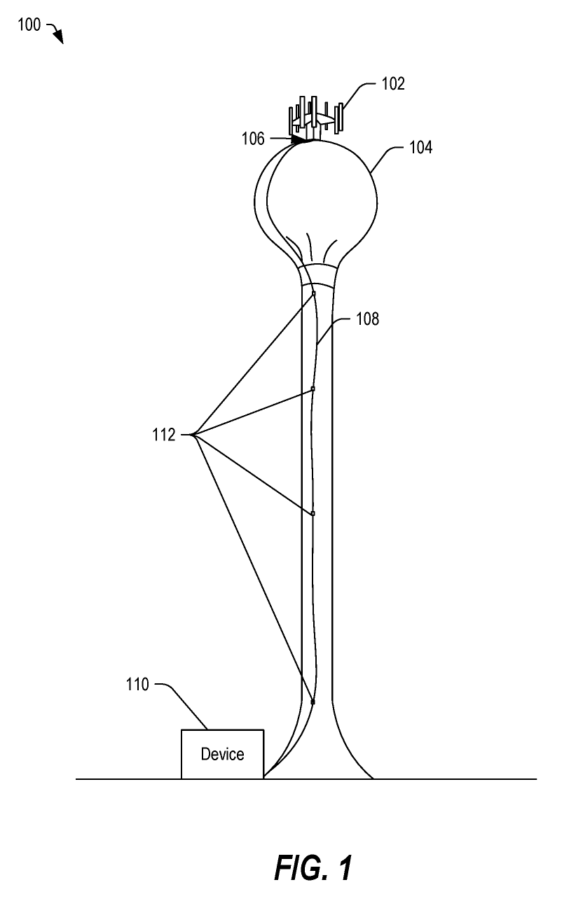

FIG. 1 depicts a side view of a system 100 including an antenna device 102 mounted to a water tower 104 by a mounting structure 106 and including cables 108 extending from the antenna device 102 to a device 110 on or near the ground and secured by a plurality of magnetic cable hangers 112, in accordance with certain embodiments of the present disclosure. In some embodiments, the cable hangers 112 may include a mounting base portion configured to magnetically couple to the side of the water tower 104 (or to the side of another metallic structure). Further, the cable hangers 112 may include a clip structure configured to engage one or more cables and to secure the cables (or a cable conduit) to the mounting base. While four cable hangers 112 are depicted in FIG. 1, it should be understood that any number of cable hangers 112 may be used, depending on the implementation.

While the example depicted in FIG. 1 includes a cellular antenna having a pillar-type of mounting structure, other types of antenna or electronic devices may be coupled to a structure, such as the water tower 104. Further, in some embodiments, the cable hangers 112 may be positioned along an upper surface of the structure as well as along the sides to secure the cables. Other embodiments are also possible.

In some embodiments, each cable hanger 112 may include a permanent (rare earth) magnet, which may be fastened to the mounting base portion and which may be configured to secure the mounting base portion to a metallic portion of the supporting structure. Further, the mounting base portion of the cable hanger 112 may be configured to receive multiple clip structures, such that multiple cables, sets of cables, or cable conduits such that each cable hanger 112 may be configured to secure one or more cables, sets of cables, or conduits.

It should be appreciated that the one or more cables 108 may include power cables, data cables, or any combination thereof. Further, it should be understood that a water tower 104 represents one possible example of a structure to which the antenna 102 and the cable hangers 102 may be coupled. In other embodiments, the cable hanger 112 may be coupled to any metallic structure. In some embodiments, the cable hangers 102 may utilize rare earth magnets that may be able to support twenty-five to one hundred pounds of force. In some embodiments, larger (stronger) rare earth magnets may be used to secure heavier cables or a larger number of cables or conduits. Other embodiments are also possible.

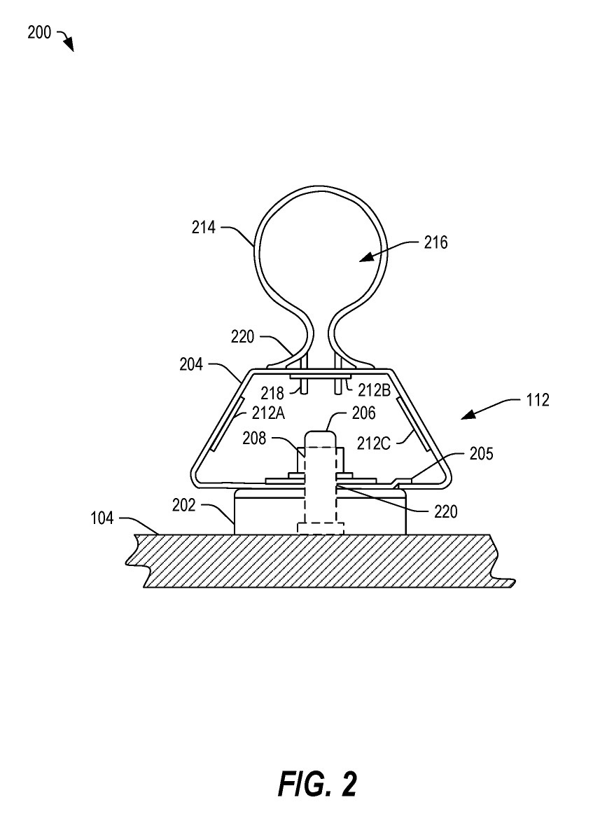

In general, the magnetic cable hanger 112 may include two components: a mounting base that includes or that can be attached to a magnet and one or more cable clips that can be attached to the base element. Each clip may be configured to engage or hold one or more cables or a conduit and may be configured to releasably couple to the mounting base. Further, the mounting base may be configured to receive a plurality of cable clips. The magnet of the mounting base may be configured to secure the cable hanger to a structure, such as a leg or base of metal structure or tower. One possible example of a magnetic cable hanger is described below with respect to FIG. 2.

FIG. 2 depicts a side view 200 of a magnetic cable hanger 112 including a cable clip 214 coupled to a mounting base 204, in accordance with certain embodiments of the present disclosure. The mounting base 204 may be coupled to a magnet 202 by a fastener 206, which may extend through an opening in the magnet 202 and through an opening 220 in the mounting base 204 and may be secured by a washer 210 and a nut 208. The magnet 202 is depicted as being coupled to the water tower structure 104, but could be any metallic supporting structure.

In some embodiments, the mounting base 204 may be formed from a unitary piece of material that may be bent or otherwise formed into a trapezoidal shape. The ends of the unitary piece of material may include an overlapping portion 205 configured to maintain the trapezoidal shape. Further, in some embodiments, ridges may be formed in the mounting base 204 to provide reinforcing structure to dissipate shearing stresses due to forces (such as wind) applied to the cables and transferred from one or more cable clips 214 to the mounting base 204.

In some embodiments, the mounting base 204 may include one or more openings 212 configured to receive one or more cable clips 214. Each cable clip 214 includes a circular portion defining an opening 216 configured to receive one or more cables or a conduit. In the illustrated example, the mounting base 204 includes a first opening 212A, a second opening 212B, and a third opening 212C. The openings 212 may be configured to receive and secure a portion of a corresponding cable clip 214. In this illustrated example, only the second opening 212B is coupled to a cable clip 214.

In the illustrated example, the cable clip 214 may include the circular portion, a connector portion 218 that extends through the opening 212B, and footing portions 220 on either side of the opening 212B. The connector portion 217 may be compressed to fit through the opening 212 and then released. When the connector portion 218 of the cable clip 214 is released, the elastic property of the material of the cable clip 214 may cause the connector portion 218 to expand. Further, the footing portions 220 may press against the surface of the mounting base 204 to compress the connector portion 218 against the interior surface of the opening 212B and optionally against an interior surface of the unitary piece of material that forms the trapezoidal mounting base 204. Other embodiments are also possible.

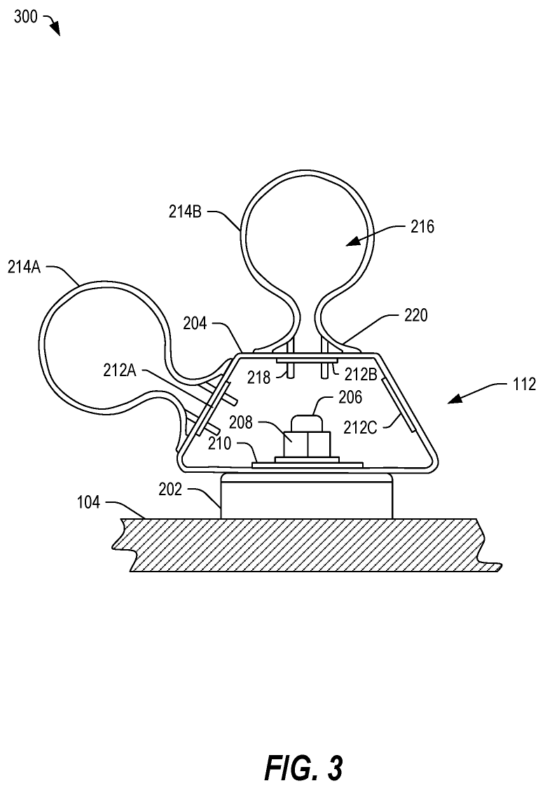

FIG. 3 depicts a side view 300 of the magnetic cable hanger 112 including a pair of cable clips 214A and 214B coupled to the mounting base 204, in accordance with certain embodiments of the present disclosure. In the illustrated example, a third cable clip 214 may be coupled to the third opening 212C to secure additional cables or another cable conduit. Other embodiments are also possible.

In some embodiments, the magnetic cable hanger 112 may include the mounting base 204 that may be open along at least one side to allow the user to access the nut 208 to secure the magnet 202 to the bottom opening in the mounting base 204. In some embodiments, the mounting base 204 may include multiple openings configured to receive the connector portion 218 of one or more clips 214 in order to secure one or more cables or conduits to a structure, such as the leg, support or base of a water tower or another metallic structure.

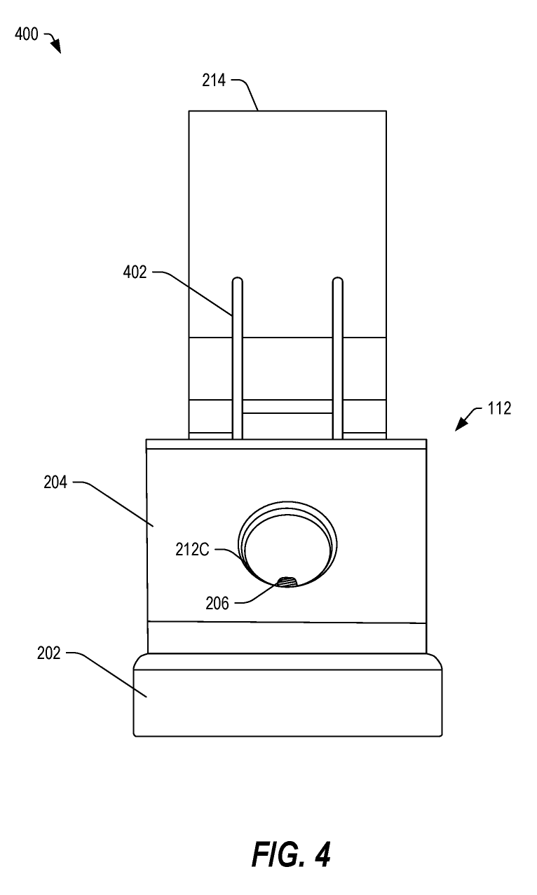

FIG. 4 depicts a side view 400 of a magnetic cable hanger 112, in accordance with certain embodiments of the present disclosure. In the illustrated example, the magnetic cable hanger 112 includes a cable clip 214 including a connector portion 218 and footing portions 220. The connector portion 218 may bend or fold to fit into the opening 212B through the surface of the mounting base 204, and the footing portions 220 may bend or fold to fit against an exterior surface of the mounting base 204.

The mounting base 204 may include opening 212B (not visible beneath the cable clip 214) and opening 212C. The end of the fastener 206 is visible through the opening 212C. Further, the mounting base 204 may be coupled to the magnet 202 by the fastener 206. In this particular example, the magnet 202 may be wider that the depth of the mounting base 204. In other embodiments, the magnet 202 may have a circumferential profile that is equal to or less than the depth of the mounting base 204. Other embodiments are also possible.

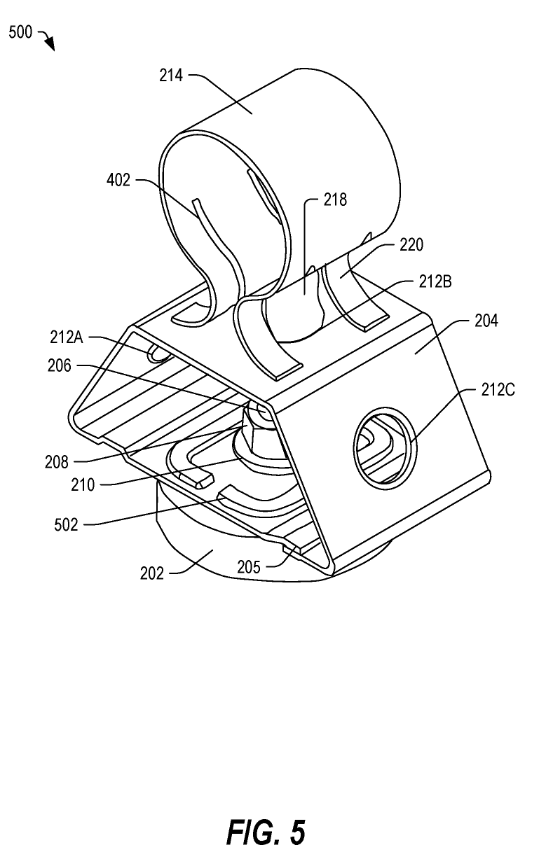

In the illustrated example, the cable clip 214 includes cut-outs 402, which allow the connector portion 218 to be bent to provide a first curvature and which allows the footing portions 220 to be bent to provide a second curvature. The bends of the connector portion 218 and the footing portions 220 can be seen in the perspective view of FIG. 5.

FIG. 5 depicts a top perspective view 500 of a magnet cable hanger 112, in accordance with certain embodiments of the present disclosure. The magnet cable hanger 112 may include a mounting base 204 coupled to a cable clip 214. The cable clip 112 includes footing portions 220 and a connection portion 218. The connection portion 218 may extend into and through the opening 212B. The connection portion 218 may be curved and bent to fit through the opening 212B, and the footing portions 220 may be bent differently and configured to engage an exterior surface of the mounting base 204. The footing portions 220 may bias the cable clip 214 such that a ridge or extension feature on the connection portion 218 may engage an interior surface of the mounting base 218. The footing portions 220 may push against the exterior of the mounting base 204 causing the ridge of the connection portion 218 to engage the interior surface of the mounting base. Other embodiments are also possible

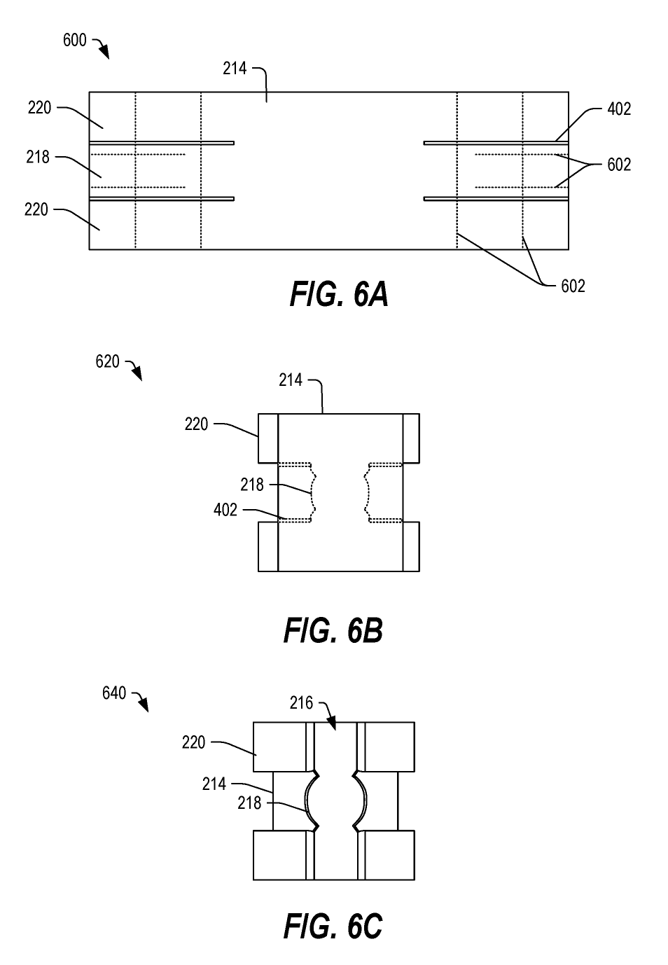

FIG. 6A depicts a top view of a sheet 600 of material including cut outs 402 and bend-lines 602 and 604 for forming a cable clip, such as the cable clip 214 of FIGS. 2-5, in accordance with certain embodiments of the present disclosure. The sheet 500 may be cut from a larger sheet and may include cut outs 402, which may be stamped, etched or carved into the sheet 600. The cut sheet 600 may then be bent at or near the bend lines 604 to provide a curvature configured to fit into one of the openings 212.

FIG. 6B depicts a top view 620 of the sheet of material after bending to form the cable clip of FIGS. 2-5, in accordance with certain embodiments of the present disclosure. From the top view, a portion of the footings 220 may extend beyond a profile of the curved portion of the cable clip 214 and a portion is shown in phantom. Further, the curvature of the connector portion 218 is also shown in phantom including a curved portion that can fit into or partially through one of the openings 212 in the mounting base 204. Other embodiments are also possible.

FIG. 6C illustrates a bottom view 640 of the cable clip 112 of FIG. 6C, in accordance with certain embodiments of the present disclosure. In this view, the connector portion 218 can be seen as including a curvature that may be configured to fit within or through the opening 212 in the mounting base. Further, the footing portions 220 may extend beyond a profile of the cable clip 214. Additionally, the cable clip 214 may define an opening 216 sized to receive and secure one or more cables.

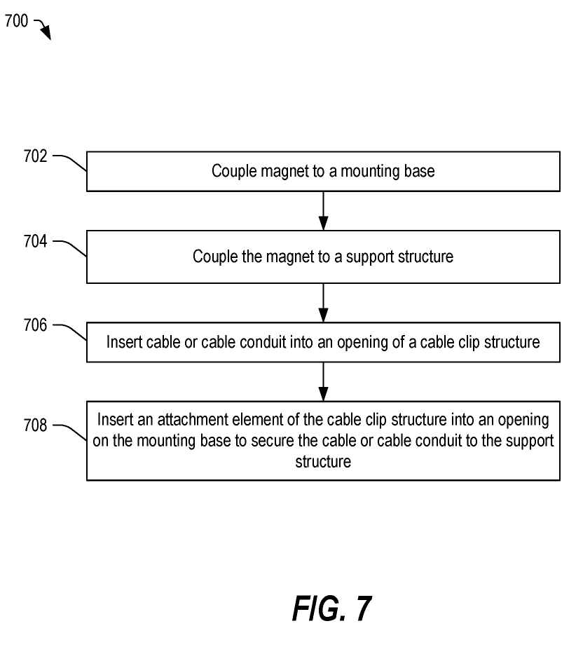

FIG. 7 depicts a flow diagram of a method 700 of installing a magnetic cable hanger, in accordance with certain embodiments of the present disclosure. At 702, the method 700 may include coupling a magnet to a mounting base. In a particular embodiment, the magnet may be bolted, welded, or otherwise secured to the mounting base. In a particular example, the magnet may be secured to the mounting base by a threaded fastener so that a first planar surface of the magnet contacts the mounting base. The compression applied by the fastener may prevent the magnet from pivoting or moving relative to the mounting base. In certain embodiments, a bolt may be tightened onto a threaded fastener to couple a magnet to the mounting base.

At 704, the method 700 can include coupling the magnet to a support structure. In some embodiments, the support structure may be a building, a water tower, a radio tower, or another structure. The magnet may be coupled to the support structure by moving the magnet/mounting base assembly into contact with the support structure. In some embodiments, coupling the magnet to the support structure may include magnetically coupling a mounting base to the structure. The mounting base may include a plurality of clip openings sized to receive an attachment feature of a cable clip.

At 706, the method 700 can include inserting a cable or cable conduit into an opening of a cable clip structure. In some embodiment, the cable clip structure may include a horseshoe shape or circular shape feature configured to receive and secure a cable or conduit and at least one attachment element or feature configured to couple the cable clip structure to the mounting base.

At 708, the method 700 may include inserting an attachment element of the cable clip structure into an opening on the mounting base to secure the cable or cable conduit to the support structure. In an example, the method 700 may include mechanically coupling a cable clip to a selected one of the plurality of clip openings. In some embodiments, the clip openings may have a substantially circular shape, an elliptical shape, a horseshoe shape, another shape, or any combination thereof. In some embodiments, the attachment element of the cable clip structure may include a hook, clip, or other feature configured to engage an opening or other attachment feature associated with the mounting base. In an example, the cable clip structure may include a first portion configured to engage an opening in the mounting base and a second portion configured to engage a surface of the mounting base to secure the clip structure to the mounting base.

In certain embodiments, mechanically coupling the cable clip to a selected one of the plurality of clip openings can include compressing a portion of the cable clip into a compressed state and inserting the portion into the selected one of the plurality of clip openings while it is held in the compressed state. Further, the compressed portion of the cable clip may include releasing the portion to allow the portion to expand within the selected one of the plurality of clip openings to secure the cable clip to the mounting base.

In conjunction with the devices and methods described above with respect to FIGS. 1-7, a device may include a mounting base that may be magnetically coupled to a structure. The mounting base may include one or more openings. Further, the device may include one or more cable clips, which may be configured to couple to one of the one or more of the openings. In some embodiments, each cable clip may be configured to secure one or more cables or a conduit.

Although the present invention has been described with reference to preferred embodiments, workers skilled in the art will recognize that changes may be made in form and detail without departing from the scope of the invention.

What is claimed is:

1. A device comprising:
a mounting base including a magnet configured to couple to a support structure, the mounting base further including at least one clip opening; and
at least one cable clip, each cable clip including:
a first portion configured to secure at least one of a cable and a conduit; and
a connection portion configured to engage the at least one clip opening to couple the at least one clip to the mounting base.

2. The device of claim 1, wherein each cable clip is formed from a unitary piece of material.

3. The device of claim 1, each cable clip further comprises a footing portion formed to fit against an exterior surface of the mounting base.

4. The device of claim 1, wherein the mounting base is formed from a unitary piece of material bent to form a substantially trapezoidal shape.

5. The device of claim 1, wherein the mounting base includes an overlapping portion corresponding to ends of the unitary piece of material.

6. The device of claim 1, wherein the mounting base further includes:
a mounting side configured to engage the magnet;
a first side extending from the mounting side at an acute angle relative to the mounting side;
a second side coupled to the first side and extending parallel to the mounting side; and
a third side coupled to the second side and extending at an obtuse angle relative to the second side and at an acute angle relative to the mounting side such that the mounting base has a substantially trapezoidal shape.

7. The device of claim 6, further including:
a first opening configured to receive a fastener to couple the magnet to a first exterior surface of the mounting side of the mounting base; and
wherein the at least one clip opening includes:
a first clip opening on the first side;
a second clip opening on the second side; and
a third clip opening on the third side.

8. A device comprising:
a magnet;
a mounting base coupled to the magnet and including one or more clip openings; and
one or more cable clips configured to secure at least one of a cable and a conduit, each cable clip configured to couple to a selected one of the one or more clip openings of the mounting base.

9. The device of claim 8, wherein each cable clip is formed from a unitary piece of material.

10. The device of claim 8, wherein each cable clip comprises:
a first portion configured to secure the at least one of the cable and the conduit; and
a connection portion configured to engage the at least one clip opening of the one or more clip openings of the mounting base to couple the cable clip to the mounting base; and
a footing portion formed to fit against an exterior surface of the mounting base.

11. The device of claim 8, wherein the mounting base is formed from a unitary piece of material bent to form a trapezoidal shape.

12. The device of claim 8, wherein the mounting base includes an overlapping portion corresponding to ends of the unitary piece of material.

13. The device of claim 8, wherein the mounting base further includes:
a mounting side;
a first side extending from the mounting side at an acute angle relative to the mounting side;
a second side coupled to the first side and extending parallel to the mounting side; and
a third side coupled to the second side and extending at an obtuse angle relative to the second side and at an acute angle relative to the mounting side to form a trapezoidal shape.

14. The device of claim 13, further including:
the mounting side including a first opening configured to receive a fastener to couple the magnet to a first exterior surface of the mounting base; and
wherein the at least one clip opening includes:
a first clip opening on the first side;
a second clip opening on the second side; and
a third clip opening on the third side.

15. A method comprising:
magnetically coupling a mounting base to a structure, the mounting base including a plurality of clip openings; and
mechanically coupling an attachment feature of a cable clip at least one of the plurality of openings, the cable clip including a first portion configured to secure at least one of a cable and a conduit to the structure.

16. The method of claim 15, wherein mechanically coupling the cable clip to the selected one comprises:
compressing a portion of the cable clip into a compressed state;
inserting the portion into the selected one of the plurality of clip openings while it is held in the compressed state; and
releasing the portion to allow the portion to expand within the selected one of the plurality of clip openings to secure the cable clip to the mounting base.

17. The method of claim 15, wherein before mechanically coupling the cable clip to the selected one of the plurality of clip openings, the method further comprises:
securing at least one of a cable and a conduit within a circular portion of the cable clip.

18. The method of claim 15, wherein before magnetically coupling the mounting base to the structure, the method further comprises:
tightening a bolt onto a threaded fastener to couple a magnet to the mounting base.

19. The method of claim 15, wherein the structure comprises a water tower.

20. The method of claim 15, wherein each clip opening of the plurality of clip openings comprises a substantially circular opening.
